(19) United States
(12) Patent Application Publication
(10) Pub. No.: US 2015/0059810 A1
(43) Pub. Date: Mar. 5, 2015

(54) CYCLONIC DEBRIS REMOVAL APPARATUSES AND ASSOCIATED METHODS

(71) Applicant: Garlock Pipeline Technologies, Inc., Charlotte, NC (US)

(72) Inventor: Ian W. Brown, Charlotte, NC (US)

(73) Assignee: GARLOCK PIPELINE TECHNOLOGIES, INC., Charlotte, NC (US)

(21) Appl. No.: 14/018,227

(22) Filed: Sep. 4, 2013

(51) Int. Cl. B08B 5/00; B04C 3/00

(52) U.S. Cl. CPC B08B 5/00; B04C 3/00
USPC 134/25.1; 15/316.1

(57) ABSTRACT

An improved apparatus, system, and method for removing debris from lightweight components are disclosed. The improved apparatus can include an air mover, a cyclonic chamber in fluid communication with the air mover, an enclosure component operably attached with the cyclonic chamber, and a debris collection component in fluid communication with the cyclonic chamber. The lightweight components positioned inside the cyclonic chamber can be moved, rotated, or carried by cyclonic airflow, causing the lightweight components to hit against one another or against the sidewall, so as to separate the debris clung thereto.

### CROSS-REFERENCE TO RELATED PATENT APPLICATIONS

None

### BACKGROUND

When manufacture of components (e.g., a plastic tube) involves a cutting process (e.g., by a drum cutter), dust and debris can be statically energized and cling to these components. A conventional way to remove undesirable dust or debris is applying suitable airflow to these components individually. The undesirable dust or debris can be moved and carried away by suitable airflow. However, the conventional way of removing undesirable dust or debris can be extremely time consuming and thus inefficient. Therefore, improved apparatuses, systems, or methods for removing dust or debris from manufactured components are desirable.

### SUMMARY

The technology of the present application is directed to an improved apparatus, system, and associated method for removing debris from lightweight components. The improved apparatus can include an air mover, a cyclonic chamber in fluid communication with the air mover, an enclosure component operably attached with the cyclonic chamber, and a debris collection component in fluid communication with the cyclonic chamber. The lightweight components positioned inside the cyclonic chamber can be moved, rotated, or carried by cyclonic airflow, causing the lightweight components to hit against one another or against the sidewall, so as to separate the debris clung thereto.

The technology of the present application also discloses a method of removing debris from lightweight components. The method can include: positioning the lightweight components in a cyclonic chamber; providing an incoming airflow path to the cyclonic chamber along a substantial tangential direction; generating cyclonic airflow in the cyclonic chamber; carrying, moving, or rotating the lightweight components by the cyclonic airflow; removing debris attached with the lightweight components at least by causing the lightweight components to hit against one another or against an inner surface of the cyclonic chamber; and collecting the separated debris by a debris collection component.

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

These and other aspects of the present technology will be apparent after consideration of the Detailed Description and Drawings herein.

### DRAWINGS

Non-limiting and non-exhaustive embodiments of the present technology, including the preferred embodiment, are described with reference to the following figures, wherein like reference numerals refer to like parts throughout the various views unless otherwise specified.

FIG. 1 illustrates a system for removing debris in accordance with an exemplary embodiment of the present technology.

FIG. 2 illustrates a system for removing debris in accordance with another exemplary embodiment of the present technology.

FIG. 3 illustrates a cyclonic chamber in accordance with an exemplary embodiment of the present technology.

FIG. 4 illustrates a cyclonic chamber in accordance with another exemplary embodiment of the present technology.

FIG. 5 is a schematic top view of a cyclonic chamber in accordance with an exemplary embodiment of the present technology.

FIG. 6 is a schematic top view of a cyclonic chamber in accordance with another exemplary embodiment of the present technology.

FIG. 7 is a schematic side view of a cyclonic chamber in accordance with an exemplary embodiment of the present technology.

FIG. 8 is a flowchart depicting a method in accordance with an exemplary embodiment of the present technology.

### DETAILED DESCRIPTION

The technology of the present application is described with specific reference to an apparatus for removing debris clung to a plurality of lightweight components. The term “lightweight component” can be defined as components that can be moved, rotated, or carried by suitable airflow. As, as used herein, the terms “debris”, “dust”, “dirt”, or the like are used relatively interchangeably to mean any unwanted particle remaining on the lightweight components subsequent to processing whether the particle remains on the lightweight component due to static electric energy or other adhesion. Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

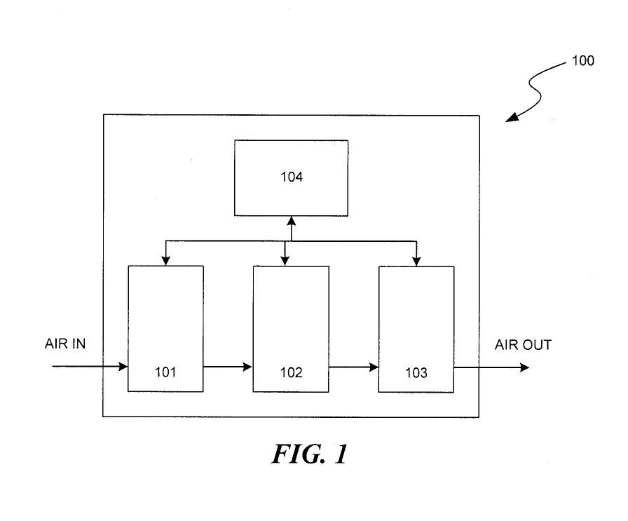

FIG. 1 illustrates a system 100 in accordance with an exemplary embodiment of the present technology. The system 100 can be used to remove debris or dust from lightweight components whose manufacturing processes involve cutting. For example, the lightweight components can be plastic tubes, other plastic components, or other hollow components. As shown in FIG. 1, the system 100 can include an air mover 101, a cyclonic chamber 102, a debris collection component 103, and a controller 104. The air mover 101 can be configured to generate airflow for moving, rotating, or carry lightweight components positioned in the cyclonic chamber 102. The air mover 101 in certain aspects may be a compressor, pump, or the like. In still other aspects, the air mover 101 may be a pressurized reservoir. Also, while describes as an air mover 101, it will be appreciated by a person of ordinary skill in the art that air mover 101 could supply other gases, such as, for example, helium, nitrogen, argon, etc. The cyclonic chamber 102 is in fluid communication with the air mover 101 and can accommodate the lightweight components to be cleaned. In some embodiments, the cyclonic chamber 102 can have a cylindrical shape. In other embodiments, the cyclonic chamber 102 can have a bucket shape. In other embodiments, the cyclonic chamber 102 can have other suitable shapes, such as an elliptic cylinder, a portion of a cone, an oblique elliptic cone, or shapes that can facilitate creating cyclonic airflow therein.

The cyclonic chamber 102 can have an air inlet, an air outlet, and a sidewall. The airflow generated by the air mover 101 can be directed into the cyclonic chamber 102 via the air inlet. The air inlet can be positioned on the sidewall, so as to allow the directed airflow to generate cyclonic (or spiral) airflow inside the cyclonic chamber 102. The cyclonic airflow generated inside the cyclonic chamber 102 can cause lightweight components positioned in the cyclonic chamber 102 to hit against one another or against the sidewall, so as to separate the debris clung thereto.

In one exemplary embodiment, the cyclonic chamber 102 can have a bucker shape whose volume is around 5 gallons. An exemplary operating time of separating or removing debris, for example, can be 30 seconds. An exemplary number of lightweight components that can be position in the cyclonic chamber at one time can range up to about 200 to 225 parts. In other embodiments, the volume of the cyclonic chamber 102, the operating time of separating or removing debris, and the number of lightweight components can vary depending on multiple factors, such as the sizes and/or materials of the lightweight components, efficiency of the air mover 101, the size and/or shape of the cyclonic chamber 102, or required cleaning results.

The debris collection component 103 is in fluid communication with the cyclonic chamber 102 via the air outlet. The separated debris can be carried by airflow leaving the cyclonic chamber 102 and then can be collected by the debris collection component 103. In some embodiments, the debris collection component 103 can be a debris collection chamber (or a catch box) that can collect debris carried by passing airflow. For example, the debris can be collected by deposition, screening, meshing, or other suitable means. In other embodiments, the debris collection component 103 can be a filter designed to remove the carried debris. In still other applications, the debris collection component 103 is optional and the system may exhaust to atmosphere.

The controller 104 can be coupled to the air mover 101, the cyclonic chamber 102, and the debris collection component 103. The controller 104 can include a processor and a memory. In some embodiments, the controller 104 can monitor the statuses of the air mover 101, the cyclonic chamber 102, and the debris collection component 103 by receiving signals from suitable sensors. In other embodiments, the controller 104 can adjust the operation of the air mover 101, the cyclonic chamber 102, and the debris collection component 103 based on the received signals. For example, the controller 104 can increase the airflow generated by the air mover 101 when the controller 104 detects that the cyclonic airflow in the cyclonic chamber 102 is insufficient to move, rotate, or carry the lightweight components positioned therein. In another example, the controller 104 can decrease the airflow generated by the air mover 101 when the controller 104 detects that a debris-removing efficiency of the debris collection component 103 is below a certain threshold (e.g., providing more time for the debris collection component 103 to collect the separated debris).

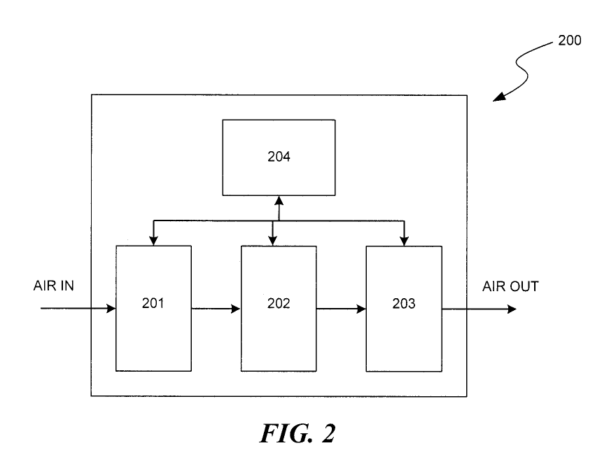

FIG. 2 illustrates a system 200 for removing debris in accordance with another exemplary embodiment of the present technology. As shown in FIG. 2, the system 200 can include an air mover 203, a cyclonic chamber 201, a debris collection component 202, and a controller 204. The air mover 203, the cyclonic chamber 201, the debris collection component 202, and the controller 204 can have similar functions as the air mover 101, the cyclonic chamber 102, the debris collection component 103, and the controller 104 described above with reference to FIG. 1. Unlike the embodiment described in FIG. 1 (i.e., the air mover 101 is positioned upstream of the cyclonic chamber 102), the air mover 203 can be positioned downstream of the cyclonic chamber 201. In the illustrated embodiment, the air mover 203 also can be positioned downstream of the debris collection component 202. In other embodiments (not shown), the air mover 203 can be positioned downstream of the cyclonic chamber 201 and upstream of the debris collection component 202.

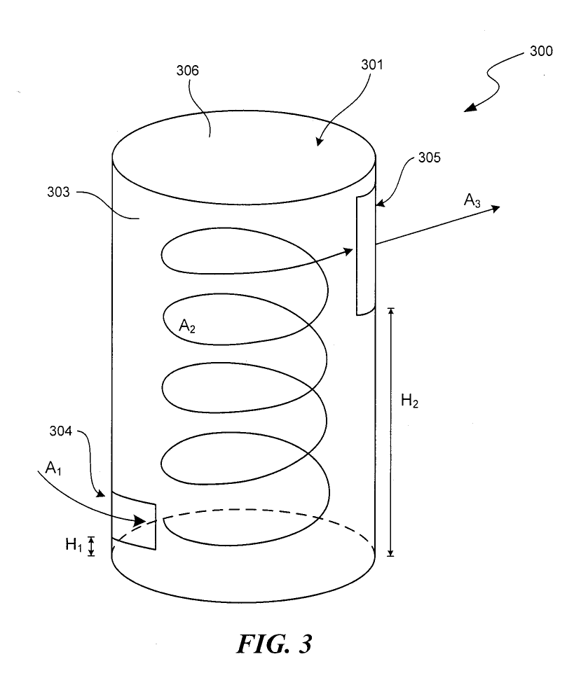

FIG. 3 illustrates a cyclonic chamber 300 in accordance with an exemplary embodiment of the present technology. As shown in FIG. 3, the cyclonic chamber 300 can include a top surface 301, a bottom surface 302, and a sidewall 303. In some embodiments, the cyclonic chamber 300 can include an enclosure component 306 operably attached with the cyclonic chamber 300. In some embodiments, the enclosure component 306 can be an operably detachable cap or lid positioned on the top surface 301. When the enclosure component 306 is open, a user can position lightweight components to be cleaned (e.g., lightweight components with undesirable debris clung thereto) in the cyclonic chamber 300. Once finished, the enclosure component 306 can be closed and secured so as to keep the lightweight components inside the cyclonic chamber 300. In some embodiments, the enclosure component 306 can facilitate to maintain a substantially airtight condition of the cyclonic chamber 300. In some embodiments, the cyclonic chamber 300 can only have the sidewall 303 with either the top surface 301 (e.g., an inverted cone shape) or the bottom surface 302 (e.g., a cone shape). In these embodiments, the enclosure component 306 can be positioned on either the top surface 301 (e.g., the inverted cone shape) or the bottom surface 302 (e.g., the cone shape).

In the illustrated embodiment, the cyclonic chamber 300 can include an air inlet 304 and an air outlet 305 both positioned on the sidewall 303. The air inlet 304 can be positioned at a first height H1 of the sidewall 303, and the air outlet 305 can be positioned at a second height H2 of the sidewall 303. In the illustrated embodiment, the first height H1 is lower than the second height H2. In some embodiment, the first height H1 can be higher than the second height H2. In other embodiments, the first height H1 and the second height H2 can be substantially the same. Also, while shown in the sidewall 303, the air inlet 304 and air outlet 305 may be positioned on either the top or bottom surfaces 301, 302.

In the illustrated embodiment, the air inlet 304 can be a rectangular opening, while the air outlet 305 can be a slot. The slot can have a width less than the dimension of individual lightweight components, so as to prevent individual lightweight components from leaving the cyclonic chamber 300 through the slot. In other embodiments, the air inlet 304 and the air outlet 305 can be in other suitable shapes, such as circles or polygons. Also, rather than a simple opening, the air inlet 304 may include a nozzle, jet, filter, perforations, or the like. Similarly, the air outlet 305 may include a screen, mesh, cover, flap, or the like.

With reference to FIG. 3, an air airflow path can be defined by an air mover (e.g., the air mover 101 or 203), the cyclonic chamber 300, and a debris collection component (e.g., the debris collection component 103 or 202). The airflow path can include an incoming airflow path A1, a cyclonic airflow path A2, and an exhaust airflow path A3. The incoming airflow path A1 may start from ambient air to the air inlet 304 of the cyclonic chamber 300. In certain aspects, the incoming airflow may originate at a source of air, such as a tank or bottle. In some embodiments, the air mover can be positioned in the incoming airflow path A1 (e.g., as embodiments described in FIG. 1). In other embodiments, the air mover can be positioned in the exhaust airflow path A3 (e.g., as embodiments described in FIG. 2).

The cyclonic airflow path A2 can travel inside the cyclonic chamber 300 from the air inlet 304 to the air outlet 305. In the illustrated embodiment, the cyclonic airflow path A2 can include an upward-spiral airflow path (as oriented and view on FIG. 3). In other embodiments, the cyclonic airflow path A2 can include linear, non-linear, circular, or irregular (e.g., turbulent) airflow paths. The lightweight components positioned in the cyclonic chamber 300 can be moved, rotated, or carried along the cyclonic airflow path A2, causing the lightweight components to hit against one another or against the sidewall 303, so as to separate undesirable debris from the lightweight components.

The exhaust airflow path A3 can start from the air outlet 305 of the cyclonic chamber 300 to ambient air, passing through the debris collection component (e.g., the debris collection component 103 or 202). The separated debris can be carried away along the exhaust airflow path A3 and collected by the debris collection component. The debris collection component can be a filter, collection chamber, catch box, or any other suitable means.

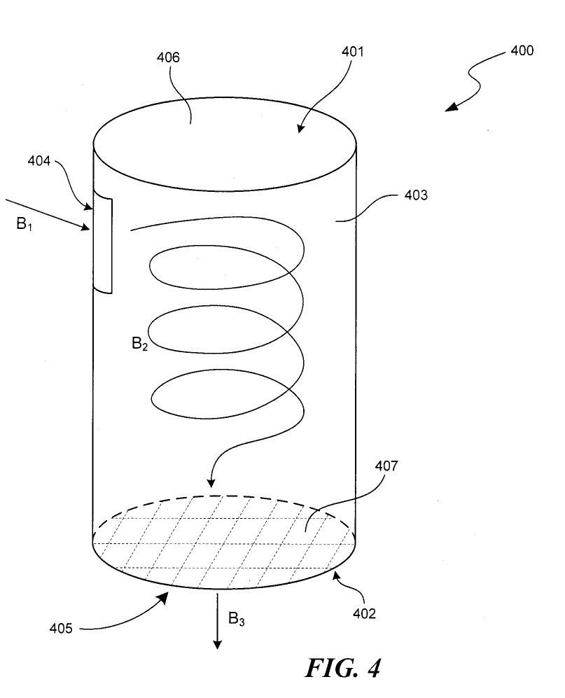

FIG. 4 illustrates a cyclonic chamber 400 in accordance with another exemplary embodiment of the present technology. As shown in FIG. 4, the cyclonic chamber 400 can include a top surface 401, a bottom surface 402, and a sidewall 403. In some embodiments, the cyclonic chamber 400 can include an operably detachable cap or lid 406 positioned on the top surface 401, allowing a user to position the lightweight components to be cleaned in the cyclonic chamber 400, and/or remove the same therefrom.

In the illustrated embodiment, the cyclonic chamber 400 can include an air inlet 404 and an air outlet 405. The air inlet 404 can be positioned on the sidewall 403. The cyclonic chamber 400 can include a wire mesh 407 positioned at the air outlet 405 on the bottom surface 402 of the cyclonic chamber 400. The wire mesh 407 can facilitate retaining the lightweight components in the cyclonic chamber 400. In other words, only separated debris can be carried by airflow passing through the wire mesh 407. In other embodiments, the wire mesh 407 can be replaced by a screen, sieve, strainer, sifter, or the like.

Similar to the embodiments described in FIG. 3 above, an air airflow path can be defined by an air mover, the cyclonic chamber 400, and a debris collection component. With reference to FIG. 4, the airflow path can include an incoming airflow path B1, a cyclonic airflow path B2, and an exhaust airflow path B3. The incoming airflow path B1 can start from ambient air to the air inlet 404 of the cyclonic chamber 400. The cyclonic airflow path B2 can travel inside the cyclonic chamber 400 from the air inlet 404 to the air outlet 405. In the illustrated embodiment, the cyclonic airflow path B2 can include a downward-spiral airflow path (as oriented and view on FIG. 4). In other embodiments, the cyclonic airflow path B2 can include linear, non-linear, circular, or irregular (e.g., turbulent) airflow paths. The lightweight components positioned in the cyclonic chamber 400 can be moved, rotated, or carried along the cyclonic airflow path B2, causing the lightweight components to hit against one another or against the sidewall 403, so as to separate undesirable debris from the lightweight components. The exhaust airflow path B3 starts from the air outlet 404 of the cyclonic chamber 400 to ambient air, passing through the debris collection component. The separated debris can be carried away along the exhaust airflow path B3 and collected by the debris collection component.

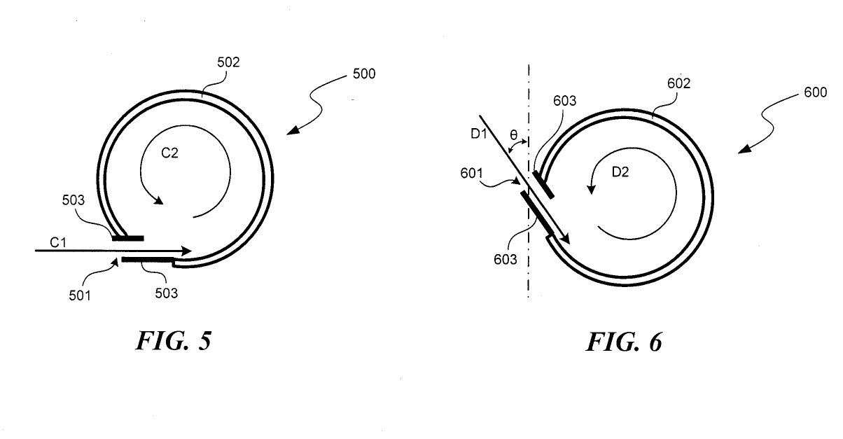

FIG. 5 is a schematic top view of a cyclonic chamber 500 in accordance with an exemplary embodiment of the present technology. As shown in FIG. 5, the cyclonic chamber 500 can include an air inlet 501 positioned on a sidewall 502. The cyclonic chamber 500 can further include an air-guiding component 503 positioned adjacent to the air inlet 501. In the illustrated embodiment, the air-guiding component 503 can be a guide plate. In other embodiments, the air-guiding component 503 can be a guide board, baffle, duct, pipe, nozzle, jet, or other suitable means for directing air flow. As shown in FIG. 5, the air-guiding component 503 defines an incoming airflow path C1 entering into the cyclonic chamber 500 in a substantively tangential direction (e.g., ±15 degrees relative to the tangential direction of the cyclonic chamber 500). This arrangement facilitates forming a cyclonic airflow path C2 inside the cyclonic chamber 500.

FIG. 6 is a schematic top view of a cyclonic chamber 600 in accordance with another exemplary embodiment of the present technology. As shown in FIG. 6, the cyclonic chamber 600 can include an air inlet 601 positioned on a sidewall 602. The cyclonic chamber 600 can further include an air-guiding component 603 positioned adjacent to the air inlet 601. In the illustrated embodiment, the air-guiding component 603 can be a guide plate. In other embodiments, the air-guiding component 603 can be a guide board, baffle, duct, pipe, nozzle, jet or other suitable means for directing air flow. As shown in FIG. 6, the air-guiding component 603 defines an incoming airflow path D1 entering into the cyclonic chamber 600 in a direction that forms an angle θ with the tangential direction of the cyclonic chamber 600. The angle θ can be an acute angle ranging from 15 to 85 degrees. This arrangement facilitates forming a cyclonic airflow path D2 inside the cyclonic chamber 600.

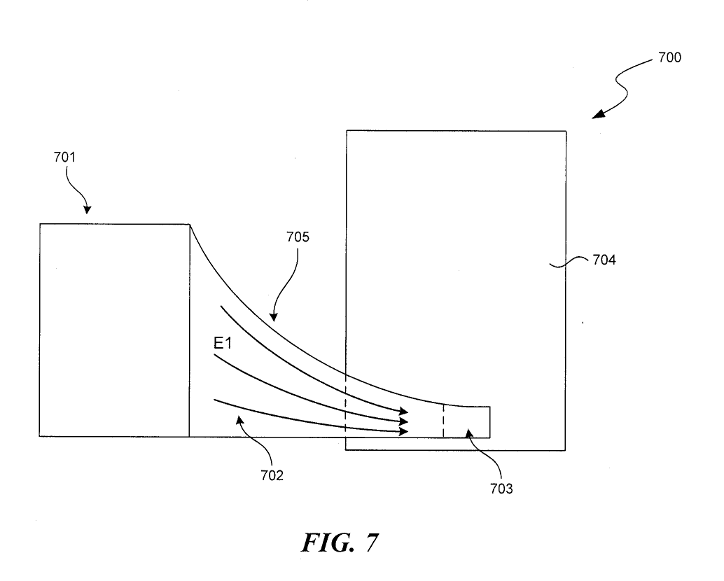

FIG. 7 is a schematic side view of a cyclonic chamber 700 in accordance with an exemplary embodiment of the present technology. As shown in FIG. 7, the cyclonic chamber 700 is in fluid communication with an air mover 701 via an air-guiding component 702. The air-guiding component 702 can be connected with the cyclonic chamber 700 at an air inlet 703 on a sidewall 704 of the cyclonic chamber 700. The air-guiding component 702 can be used to adjust the direction or the flow velocity of the airflow generated by the air mover 701, before it flows into the cyclonic chamber 700. In the illustrated embodiment, the air-guiding component 702 can be an asymmetric air duct with a convergent portion 705. The convergent portion 705 can be used to accelerate the flow speed of incoming airflow E1. In various embodiments, the flow speed of the incoming airflow E1 can be determined based on various factors, such as the types of the air mover 701, the sizes and/or materials of the lightweight components positioned in the cyclonic chamber 700, the size and/or shape of the cyclonic chamber 700, or required cleaning results. In other embodiments, the air-guiding component 702 can have a symmetric shape (e.g., a portion of the Venturi device).

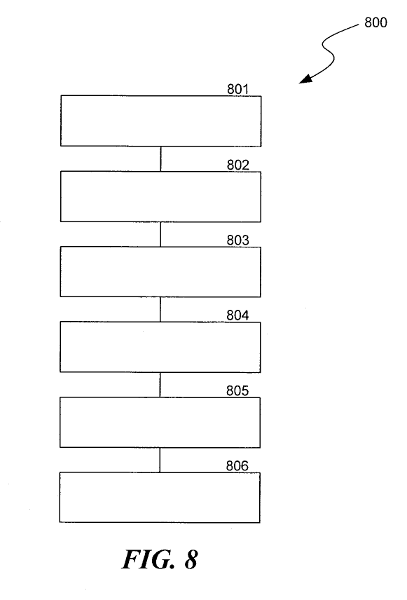

FIG. 8 is a flowchart depicting a method 800 in accordance with an exemplary embodiment of the present technology. The method 800 relates to removing debris from a plurality of lightweight components. With reference to FIG. 8, the method 800 can start at block 801 by positioning the plurality of lightweight components in a cyclonic chamber (such as the cyclonic chamber 102, 201, 300, 400, 500, 600, or 700 described above). In some embodiments, the lightweight components can be placed in the cyclonic chamber by suitable delivery systems (e.g., a belt conveyer). In other embodiments, the lightweight components can be placed in the cyclonic chamber manually.

The method can continue at block 802 by providing an incoming airflow path to the cyclonic chamber along a substantial tangential direction (e.g., arrow C1 in FIG. 5). In other embodiments, the incoming airflow path can enter into the cyclonic chamber in a direction that forms an angle θ with the tangential direction of the cyclonic chamber (e.g., arrow D1 in FIG. 6). In the illustrated embodiment, the incoming airflow path can be at least partially defined by an air-guiding component. The air-guiding component can be a guide plate/board, baffle, duct, pipe, nozzle, jet, or other suitable means.

At block 803, the method 800 can proceed by generating cyclonic airflow in the cyclonic chamber. The cyclonic airflow can include an upward-spiral airflow path (e.g., A2 in FIG. 3) or a downward-spiral airflow path (e.g., B2 in FIG. 4). In some embodiments, the cyclonic airflow can include linear, non-linear, circular, or irregular (e.g., turbulent) airflow paths. In some embodiments, the cyclonic airflow can be generated by an air mover (e.g., the air mover 101, 203, or 701). In some embodiments, the cyclonic airflow can be generated at least partially by mechanically and/or manually rotating the cyclonic chamber.

At block 804, the method 800 can proceed by carrying, moving, or rotating the plurality of lightweight components by the cyclonic airflow. The lightweight components positioned in the cyclonic chamber can be moved, rotated, or carried by the cyclonic airflow along the cyclonic airflow path. At block 805, the method 800 can continue by removing debris attached with the plurality of lightweight components at least by causing the plurality of lightweight components to hit against one another or against an inner surface of the cyclonic chamber. Vibration caused by the impact or clash among the lightweight components can effectively remove or separate undesirable debris attached therewith.

At block 806, the method 800 can end by collecting the removed debris by a debris collection component. Once the debris is separated, it will be transported outside the cyclonic chamber by exhaust airflow (e.g., A3 in FIG. 3 or B3 in FIG. 4). The exhaust airflow can direct the separated debris to the debris collection component. The debris collection component can be a debris collection chamber (or a catch box) or a filter. In some embodiments, the method 800 can further include a step of directing the cyclonic airflow to leave the cyclonic chamber via a slot. The slot, as an air outlet of the cyclonic chamber, can have a width less than the dimension of the individual lightweight component, so as to prevent the individual lightweight component from leaving the cyclonic chamber through the slot.

The technology of the present application will now be described more fully below with reference to the accompanying figures, which form a part hereof and show, by way of illustration, specific exemplary embodiments. These embodiments are disclosed in sufficient detail to enable those skilled in the art to practice the technology of the present application. However, embodiments may be implemented in many different forms and should not be construed as being limited to the embodiments set forth herein. The following detailed description is, therefore, not to be taken in a limiting sense.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. An apparatus for removing debris clung to a plurality of lightweight components, comprising:
a gas mover;
a cyclonic chamber in fluid communication with the gas mover, the cyclonic chamber having a sidewall, a gas inlet, and a gas outlet;
an enclosure component operably attached with the cyclonic chamber;
a debris collection component in fluid communication with the cyclonic chamber via the gas outlet; and
an gasflow path defined by the gas mover, the cyclonic chamber, and the debris collection component, the gasflow path including an incoming gasflow path from a source to the cyclonic chamber, a cyclonic gasflow path inside the cyclonic chamber, and an exhaust gasflow path from the cyclonic chamber to the through the debris collection component; and
wherein the plurality of lightweight components are moved, rotated, or carried in the cyclonic gasflow path, causing the lightweight components to hit against one another or against the sidewall, so as to separate the debris from the lightweight components.

2. The apparatus of claim 1, wherein the gas is air.

3. The apparatus of claim 2, wherein the source of the air is ambient.

4. The apparatus of claim 1, wherein the enclosure component includes an operably detachable component.

5. The apparatus of claim 1, wherein the gas outlet is positioned on a bottom surface of the cyclonic chamber, and wherein the debris collection component includes a collection chamber.

6. The apparatus of claim 5, further comprising a wire mesh positioned at the gas outlet so as to facilitate retaining the lightweight components in the cyclonic chamber.

7. The apparatus of claim 1, wherein the gas outlet is positioned on the sidewall of the cyclonic chamber, and wherein the gas outlet comprises a slot.

8. The apparatus of claim 1, wherein the debris collection component includes a filter.

9. The apparatus of claim 1, wherein the gas inlet is positioned on the sidewall at a first height, and wherein the air outlet is positioned on the sidewall at a second height.

10. The apparatus of claim 9, wherein the second height is greater than the first height.

11. The apparatus of claim 1, wherein the gas mover is positioned upstream in the incoming gasflow path.

12. The apparatus of claim 1, wherein the air mover is positioned downstream in the exhaust gasflow path.

13. The apparatus of claim 1, wherein the incoming gasflow path enters the cyclonic chamber in a substantively tangential direction.

14. A system for removing debris from a plurality of lightweight components, the system comprising:
an air mover configured to generate airflow;
a controller configured to adjust the airflow based on a parameter related to the plurality of lightweight components;
a cyclonic chamber in fluid communication with the air mover, the cyclonic chamber having a sidewall, an air inlet, and an air outlet, the air inlet being positioned on the sidewall; and
a debris collection component in fluid communication with the cyclonic chamber via the air outlet; and
wherein the plurality of lightweight components are positioned in the cyclonic chamber and are carried by the airflow generated by the air mover to hit against one another or against the sidewall, so as to separate the debris from the lightweight components.

15. The system of claim 14, wherein the individual lightweight components have a substantially similar shape.

16. The system of claim 14, wherein the lightweight components include at least one plastic tube.

17. The system of claim 14, wherein the air outlet is positioned on a bottom surface of the cyclonic chamber, and wherein the debris collection component includes a collection chamber.

18. The apparatus of claim 14, wherein the air outlet is positioned on the sidewall of the cyclonic chamber, and wherein the air outlet includes a slot.

19. A method for removing debris from a plurality of lightweight components, the method comprising:
positioning the plurality of lightweight components in a cyclonic chamber;
providing an incoming airflow path to the cyclonic chamber along a substantial tangential direction, wherein the incoming airflow path is at least partially defined by an air-guiding component;
generating cyclonic airflow in the cyclonic chamber;
carrying, moving, or rotating the plurality of lightweight components by the cyclonic airflow;
removing debris attached with the plurality of lightweight components at least by causing the plurality of lightweight components to hit against one another or against an inner surface of the cyclonic chamber; and
collecting the removed debris by a debris collection component.

20. The method of claim 19, further comprising directing the cyclonic airflow to leave the cyclonic chamber via a slot.

21. The method of claim 19, further comprising collecting the removed debris by a filter.

22. The method of claim 19, further comprising collecting the removed debris by a debris collection chamber.
